(19) United States
(12) Patent Application Publication
(10) Pub. No.: US 2016/0212544 A1
(43) Pub. Date: Jul. 21, 2016

(54) Planar dynamic sound transducer

(71) Applicant: Sennheiser electronic GmbH & Co. KG, Wedemark (DE)

(72) Inventors: Roland Jacques, Wedemark (DE); André Michaelis, Wedemark (DE)

(73) Assignee: Sennheiser electronic GmbH & Co. KG, Wedemark (DE)

(21) Appl. No.: 14/927,852

(22) Filed: Oct. 30, 2015

(30) Foreign Application Priority Data
Oct. 30, 2014 (DE) 10 2014 222 233.8

(51) Int. Cl. H04R 9/02; H04R 7/04

(52) U.S. Cl. CPC H04R 9/025; H04R 7/04

(57) ABSTRACT

A planar dynamic sound transducer comprising a planar diaphragm with at least one electrical conductor and at least one planar magnet arrangement which is disposed parallel to the diaphragm and which is in the form of a continuous magnet disk. The magnet disk has a first side facing towards the diaphragm and a second side facing away from the diaphragm. The magnet disk has, on the first side, in an alternating strip-wise relationship, regions which are magnetized as a North pole and regions which are magnetized as a South pole. The magnet disk, on the second side, has a plurality of openings or recesses which are arranged that they are respectively opposite the regions magnetized as the North and South pole respectively.

The present application claims priority from German Priority Application No. 10 2014 222 233.8 filed on Oct. 30, 2014, the disclosure of which is incorporated herein by reference in its entirety.

### FIELD OF THE INVENTION

It is noted that citation or identification of any document in this application is not an admission that such document is available as prior art to the present invention.

The present invention concerns a planar dynamic sound transducer.

Planar dynamic sound transducers are also referred to as planar magnetic, orthodynamic, isodynamic or magnetostatic transducers. The planar dynamic transducer is a member of the group of dynamic electromagnetic sound transducers. A planar dynamic sound transducer has a planar multi-pole magnet arrangement, a diaphragm and a second mirrored multi-pole magnet arrangement. The multi-pole magnet arrangement can have parallel magnet bars with intermediate spaces therebetween. Magnetization of the magnet bars can be in the direction of the short dimension. The two magnet arrangements repel each other, with the consequence that they should be assembled in a structure of a suitable design configuration. That results in strip-shaped magnetic fields, wherein the magenetization direction extends alternately and in particular in the direction of the short dimension of the strips.

The diaphragm between the two magnet arrangements is a flat diaphragm comprising a thin plastic film or a polyester film. Electrical conductors are provided on the diaphragm. The electrical conductors can be for example in the form of a thin wire or a vapor-deposited conductor track. The position and the direction of the electrical conductors is adapted to the magnetic poles of the two magnet arrangements. The conductors can be of a meander-shaped configuration.

FIG. 1 shows a diagrammatic sectional view of a planar dynamic transducer in accordance with the state of the art. The planar dynamic transducer 100 has a diaphragm 110 capable of vibration, with electrical conductor tracks 130. The electrical conductor tracks 130 can be of a meander-shaped configuration. The diaphragm 110 can be in the form of a diaphragm film. The transducer 100 further has a first and a second magnet arrangement 120, 140, the first magnet arrangement 120 being provided above the diaphragm 110 and the second magnet arrangement 140 beneath the diaphragm 110. The first magnet arrangement 120 has a plurality of magnet bars 121-122. The magnet bars 121-122 have first and second magnet bars 121, 122 which alternate and which are each of a different magnetization direction. A corresponding consideration applies to the magnet bars 141, 142 of the second magnet arrangement 140.

FIG. 1 shows magnetic field lines FL and a resulting force 101 on the diaphragm 110.

FIG. 2 shows a diagrammatic view of a magnet arrangement of a planar dynamic transducer according to the state of the art. In FIG. 2 there is provided a magnet arrangement 120 having a plurality of magnet bars 121, 122, which are respectively arranged in mutually spaced relationship. Adjacent magnet bars 121, 122 are of a different magnetization direction so that the field lines FL shown in FIG. 2 are produced.

The magnet arrangement 120 is in the form of a flat magnet arrangement, for example in the form of disk, and has a laterally multi-pole magnetization. Between the poles of the multi-pole magnetization there are regions which, by virtue of the pole transition, are not or are only weakly magnetized and which make no or only a slight contribution to the useful field of the magnet arrangement.

FIG. 3 shows a diagrammatic sectional view of a magnet arrangement of a planar dynamic sound transducer according to the state of the art. The magnet arrangement can be in the form of a disk 120 accommodating a plurality of magnet bars 121, 122, thus resulting in the field lines FL shown in FIG. 3.

US 2006/0050923 A1 discloses a planar dynamic sound transducer having a diaphragm and a planar magnet arrangement.

### SUMMARY OF THE INVENTION

The object of the present invention is to provide a planar dynamic sound transducer having an improved magnet arrangement.

Thus there is provided a planar dynamic sound transducer comprising a planar diaphragm with at least one electrical conductor and at least one planar magnet arrangement which is disposed parallel to the diaphragm and which is in the form of a continuous magnet disk. The magnet disk has a first side towards the diaphragm and a second side facing away from the diaphragm. The magnet disk has on the first side in alternating strip-wise relationship regions which are magnetized as a North pole and regions which are magnetized as a South pole. The magnet disk on the second side has a plurality of openings or recesses which are so arranged that they are respectively opposite the regions magnetized as the North or South pole respectively.

According to an aspect of the present invention the planar dynamic transducer has a second magnet disk which is arranged in mirror-image relationship with the first magnet disk with respect to the surface of the diaphragm.

Thus there is provided a planar dynamic sound transducer comprising a planar diaphragm with at least one electrical conductor and at least one magnet arrangement having a continuous plate or disk having a plurality of first and second magnet regions which respectively have a different magnetization direction. In other words the first magnet regions have a first magnetization direction and the second magnet regions have a second magnetization direction. The magnet arrangement has a first side with the plurality of the first and second magnet regions and a second side which is opposite to the first side. A plurality of recesses is provided on the second side of the magnetization arrangement.

The first and second magnet regions are provided within the plate.

According to an aspect of the present invention the openings are in the form of grooves which can optionally be of a triangular cross-section.

According to a further aspect of the present invention the depths of the grooves can extend to half the thickness of the magnetization arrangement.

The planar dynamic sound transducer can be provided in an earphone, a microphone or a loudspeaker.

Advantages and embodiments by way of example of the invention are described in greater detail hereinafter with reference to the drawings.

### BRIEF DESCRIPTION OF THE DRAWINGS

FIG. 1 shows a diagrammatic sectional view of a planar dynamic transducer according to the state of the art.

FIG. 2 shows a diagrammatic view of a magnet arrangement of a planar dynamic transducer according to the state of the art.

FIG. 3 shows a diagrammatic sectional view of a magnet arrangement of a planar dynamic transducer according to the state of the art.

FIG. 4 shows a diagrammatic sectional view of a magnet arrangement for a planar dynamic transducer according to a first embodiment.

### DETAILED DESCRIPTION OF THE EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein

The present invention will now be described in detail on the basis of exemplary embodiments.

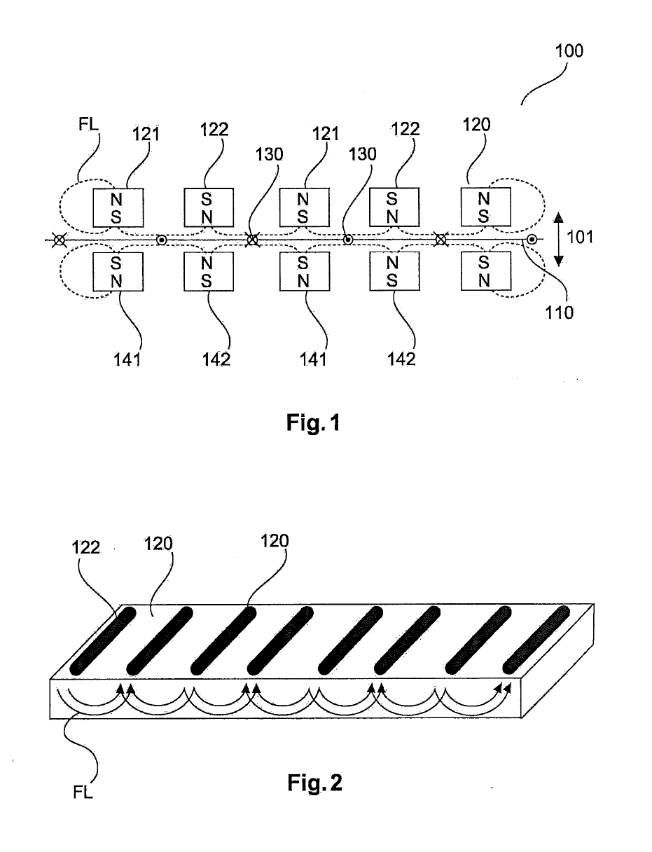

The planar dynamic sound transducer according to the invention—similarly as shown in FIG. 1—has a planar diaphragm 110 with at least one electrical conductor 130. A magnet arrangement 120 is provided above and/or below the diaphragm 110.

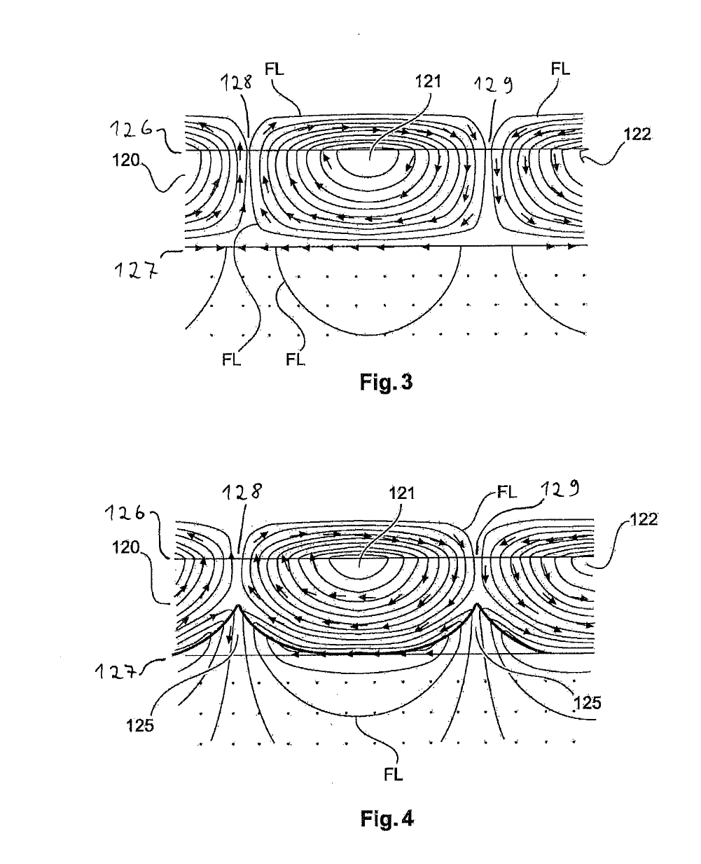

In a planar dynamic transducer, instead of individual magnet bars as shown in FIG. 1 it is also possible to use a continuous magnet disk or plate as shown in FIG. 3 which is magnetized strip-wise in opposite-pole relationship. In FIG. 3 such a magnet arrangement 120 is constructed in the form of a disk which is flat from both sides. The sectional view in FIG. 3 shows the magnetic field lines which occur upon strip-wise polarization. The magnet disk or plate which is polarized in strip-wise relationship has a first side 126 towards the diaphragm and a second side 127 facing away from the diaphragm. The strip-wise magnetization of the disk or plate 120 is such that formed on the first side 126 in alternate strip-wise relationship are regions 128 which are magnetized as a North pole and regions 129 which are magnetized as a South pole. Because of the configuration of the magnet system 120 which is continuous in plate form the magnetic return of the field lines FL which issue from the magnet plate 120 and re-enter on the first side 126 can be effected for the greatest part in the interior of the magnet plate 120 so that most field lines FL are closed in the magnet plate 120 without issuing on the second side 127. Therefore no paths with pronounced polarization occur on the second side.

FIG. 4 shows a diagrammatic sectional view of a magnet arrangement for a planar dynamic sound transducer according to a first embodiment of the invention. In a planar dynamic transducer according to the invention the magnet arrangement 120 is also in the form of a continuous magnet disk or plate which is magnetized in strip-wise opposite-pole relationship. The sectional view in FIG. 4 shows the magnetic field lines FL which occur with the strip-wise polarization. The magnet disk 120 which is polarized strip-wise has a first side 126 towards the diaphragm and a second side 127 facing away from the diaphragm. The strip-wise magnetization of the disk 120 is such that regions 128 magnetized as a North pole and regions 129 magnetized as a South pole are produced in strip-wise alternate relationship on the first side. Because of the configuration of the magnet system 120 which is continuous in plate form the magnetic return of the field lines FL which issue from the magnet disk or plate 120 and re-enter on the first side 126 can be effected for the greatest part in the interior of the magnet disk or plate 120 so that most field lines FL are closed in the magnet disk or plate 120 without issuing on the second side 127. Therefore no paths with pronounced polarization occur on the second side.

Unlike the magnet arrangement shown in FIG. 3 which is in the form of a disk that is flat from both sides, in FIG. 4 in accordance with the invention recesses or openings 125 are provided in the magnet disk 120 on the second side 127 facing away from the diaphragm. The invention is based on realization that, in the case of a magnet disk as shown in FIG. 3, within the magnet disk, there are regions which contribute practically nothing to the desired useful field which is produced in front of the first side 126 which is facing towards the diaphragm. As can be seen from FIG. 3 only few field lines FL extend on the second side 127 in the regions which are in opposite relationship to the regions on the first side 126, that are magnetized as the North pole 128 or the South pole 129.

The principle of planar dynamic transducers with the magnetic field extending over the entire diaphragm surface basically requires a relatively large amount of magnet material. That material is costly and results in the transducer being of high weight. It is therefore advantageous to reduce the amount of magnet material needed. According to the invention therefore the regions of the magnet disk 120 in which there are only few field lines FL and which therefore in practice do not contribute to the desired useful field produced in front of the first side 126 facing towards the diaphragm are cut out by recesses 125.

According to the invention therefore there is provided a planar dynamic sound transducer having at least one continuous magnet disk 120 which on the first side 126 facing towards the diaphragm has in alternate strip-wise or portion-wise relationship regions 128 magnetized as a North pole and regions 129 magnetized as a South pole and which on the second side 127 facing away from the diaphragm has openings or recesses 125 at the locations which are opposite to the regions 128, 129 which are magnetized as a North or South pole.

The planar dynamic sound transducer includes at least one of the magnet disks 120 constructed in accordance with the invention as shown in FIG. 4 and the diaphragm 110 is arranged parallel to the magnet disk at a small spacing in front of the first side 126. Optionally there can be a second magnet disk 120 in mirror-image relationship with respect to the surface of the diaphragm 110 to improve the homogeneity of the useful field. In that case both magnet disks 120 can each be provided with openings or recesses 125 on their side 127 facing away from the diaphragm.

The magnet arrangement 120 can be in the form of a continuous plate or disk and has a plurality of first and second magnet regions 121, 122 which are each of different magnetization directions. According to the first embodiment the magnet regions 121, 122 can be arranged on the top side or the first side of the magnet arrangement 120. The magnet regions can represent magnet units.

According to the invention recesses 125 are provided on the underside or the second side of the magnet arrangement 120. The recesses 125 at the second side of the magnet arrangement 120 are provided in particular in those regions which are between the adjacent magnet regions 121, 122. By virtue of those recesses 125 those regions of the magnet arrangement 120 which are magnetically not operative and which do not negatively influence mechanical stability can be removed. According to the invention therefore the form of the magnet arrangement 120 is adapted to the desired internal magnetization (strength and direction).

According to the invention the magnet arrangement can be in the form of a continuous plate or disk and can have the magnet regions. The magnet regions or magnet units are provided within the plate or disk.

According to the invention recesses or openings in the form of grooves 125 can be provided at a side 127, remote from a pole, of a magnet arrangement 120, in particular a magnet disk. The grooves 125 can optionally be of a triangular cross-section and can optionally be of a depth of penetration which can be as far as half the thickness of the magnet disk.

As can be seen from a comparison between FIG. 3 and FIG. 4 the recesses at the side 127 remote from the pole of the magnet arrangement do not have any adverse influence on the field lines at the side of the magnet arrangement, that involves the poles.

According to the invention therefore material which is magnetically ineffective is removed from the magnet arrangement like for example a magnet disk or plate. That is achieved by recesses.

A saving in material and a reduction in weight can be achieved by the configuration according to the invention of the magnet arrangement with the recesses. That can be effected in particular if the magnet arrangement is produced by injection molding, pressing, screen printing, laser sintering and so forth. If the magnet material is mechanically removed then that magnet material can be typically re-used so that there is a saving of material with a corresponding cost advantage.

In regard to the configuration of the recesses 125 care must be taken to ensure that the mechanical stability of the magnet arrangement is not excessively adversely affected. In particular attention is to be paid to the effects of the recesses on the mechanical properties of the magnet disk and the transducer system.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claim.

1. A planar dynamic sound transducer comprising:
a planar diaphragm with at least one electrical conductor; and
at least one planar magnet arrangement configured to be disposed parallel to a surface of the diaphragm which is in the form of a continuous magnet disk;
wherein the magnet disk has a first side facing the diaphragm and a second side facing away from the diaphragm;
wherein the magnet disk has, on the first side, in an alternating strip-wise relationship, regions which are magnetized as a North pole and regions which are magnetized as a South pole; and
wherein the magnet disk, on the second side, has a plurality of openings or recesses arranged that they are respectively opposite the regions magnetized as the North or South pole respectively.

2. The planar dynamic transducer as set forth in claim 1, further comprising:
a second magnet disk arranged in mirror-image relationship with the first magnet disk with respect to the surface of the diaphragm.

3. The planar dynamic transducer as set forth in claim 1;
wherein the openings or recesses are in the form of grooves.

4. The planar dynamic transducer as set forth in claim 3;
wherein the grooves are of triangular cross-section.

5. The planar dynamic sound transducer as set forth in claim 3;
wherein a depth of the grooves is up to half the thickness of the magnet arrangement.

6. An earphone comprising:
a planar dynamic sound transducer as set forth in claim 1.

7. A microphone comprising:
a planar dynamic sound transducer as set forth in claim 1.

8. A loudspeaker comprising:
a planar dynamic sound transducer as set forth in claim 1.

9. The planar dynamic transducer as set forth in claim 2;
wherein the openings or recesses are in the form of grooves.

10. The planar dynamic sound transducer as set forth in claim 4;
wherein a depth of the grooves is up to half the thickness of the magnet arrangement.
